(19) United States
(12) Patent Application Publication
(10) Pub. No.: US 2022/0404104 A1
(43) Pub. Date: Dec. 22, 2022

(54) GREEN ENERGY THERMAL STORAGE SYSTEM

(71) Applicant: HOLTEC INTERNATIONAL, Camden, NJ (US)

(72) Inventors: Krishna P. SINGH, Jupiter, FL (US); Indresh RAMPALL, Cherry Hill, NJ (US); Stephen J. AGACE, Middletown, DE (US)

(73) Assignee: HOLTEC INTERNATIONAL, Camden, NJ (US)

(21) Appl. No.: 17/837,853

(22) Filed: Jun. 10, 2022

Related U.S. Application Data
(60) Provisional application No. 63/297,899, filed on Jan. 10, 2022.
(60) Provisional application No. 63/209,234, filed on Jun. 10, 2021.

(51) Int. Cl. F28D 20/02; F22B 1/02; F24H 7/02; F22G 1/00

(52) U.S. Cl. CPC F28D 20/021; F22B 1/028; F24H 7/0233; F22G 1/00; F28D 2020/0078

(57) ABSTRACT

A thermal energy storage system includes one or more containment vessel comprising an internal cavity containing a bed of phase change material (PCM) operable to store thermal energy, an array of heaters embedded in the molten phase change material, and a tube bundle. The heaters are electrically coupled to an electric power source and operable to heat and melt the PCM to a molten state. The tube bundle comprises heat exchanger tubes embedded in the molten PCM and configured to convey a working fluid (e.g., water or other) through a tube-side of the tubes. The tubes may be arranged in plural individual tube cartridge each insertable and removable from the vessel. In operation, the working fluid is heated by absorbing stored thermal energy from the molten phase change material. The PCM may be heated by power extracted from the power grid during off-peak demand periods.

### CROSS-REFERENCE TO RELATED APPLICATIONS

The present application claims the benefit of priority to U.S. Provisional Patent Application No. 63/297,899 filed Jan. 10, 2022, and U.S. Provisional Patent Application No. 63/209,234 filed Jun. 10, 2021. The foregoing applications are all incorporated herein by reference in their entireties.

### FIELD OF THE INVENTION

The present invention relates to energy storage systems, and more particularly to such a system which utilizes a heat-absorbing phase change material (PCM) operable to store thermal energy from electricity extracted from the electric power grid or other source of electric, and produces hot water for district heating or other purposes, or steam to generate electric power via the Rankine cycle during peak electric power grid load demand periods.

### BACKGROUND OF THE INVENTION

As the transformation of the traditional energy generation landscape to non-polluting “green” energy accelerates, tens of thousands of fossil-fired power plants (especially coal-fired plant) around the world are headed to premature shutdown and decommissioning. In fact, supported by an emerging consensus to decarbonize the economy, the process of decommissioning older fossil plants has already begun in favor of more environmentally friendly non-polluting “green” alternatives for generating electric power. The resulting destruction and waste of capital assets is estimated to be in trillions of dollars even though other equipment of the traditional steam-to-electric Rankine power generation cycle shown in FIG. 1A besides the fossil-fueled boiler (i.e. steam generator) remain fully functional and viable for continued operation in many cases.

Another outcome of the rise of green energy renewables is the increased oscillation (highs and lows) in power generation levels which calls for energy storage systems to levelize the power delivered to the electric power grid by such green generating systems.

### SUMMARY OF THE INVENTION

The present disclosure provides an environmentally friendly “green” thermal energy storage system which renders its stored thermal energy when desired to heat a heat transfer working fluid. The working fluid may be water or a water mixture in some embodiments and applications; however, other types of working fluid may be used in other applications. The system comprises one or more thermal energy containment vessels which contain a bed of phase change material (PCM) which absorbs and stores heat derived from an electric power source. The PCM heats the working fluid which flows through the vessel(s) on demand for various purposes.

In some embodiments, the present thermal energy storage system may be used to heat water for district heating or other uses. In other embodiments, the thermal energy storage system may be used to produce steam for the generation of electric power. Although for any of these applications electric power is preferably extracted from a source of electricity such as the electric power grid to heat the PCM in the vessel as further described herein during off-peak load demand periods of the grid when energy prices are low, these thermal energy systems may extract electric power from the source during other period including peak load demand periods when necessary. Accordingly, the timing of when electric power is drawn from the power grid or other source for storage as thermal energy is not limited to any specific period of time.

In the latter application above, the technology disclosed herein replaces the traditional fossil boiler portion of the Rankine power generation cycle with a “Green Boiler” which functions as both an energy storage device and corresponding “on-demand” steam generation and power producer without consuming any fossil fuel. Thus, the enormous capital investment in the fossil power plants would be largely saved while mankind's energy decarbonization objectives will be realized in full measure.

A green thermal energy storage and power generation system according to the present disclosure provides the means to align its electric power output to the fluctuating load demand of the electric power grid is given the moniker “Green Boiler” herein because the system can be retrofit and installed at an existing fossil energy power generation site and operated to provide on-demand steam and electric power eliminating the usage of fossil fuel at the power generation site. The turbogenerator and the associated remaining Rankine cycle equipment infrastructure of the traditional fossil-burning power plant are retained; only the fossil-fuel boiler and its associated sub-system components are removed and replaced.

Accordingly, the Green Boiler technology disclosed herein is envisioned to replace an existing electric power plant's fossil fuel-burning boiler with a “Green Boiler system,” which converts the power plant into both an energy storage facility as well as a clean electricity generator. The Green Boiler system can also be a standalone energy storage unit in some embodiment that receives its input energy from an associated solar, wind, or a nuclear plant.

The present “Green Boiler” concept relies on the fact that the electricity delivered to the electric power grid by generating plants during most periods of a 24-hour day exceeds the actual real-time consumer (i.e. industrial, commercial, or residential) demand for power. This means that there are windows of time when there is cheap surplus power available but unfortunately wasted. The Green Boiler will take the surplus energy from the grid, or alternatively directly from a co-located green energy plant (e.g., solar, wind, or nuclear), and thermally store the energy in a phase change material (PCM) such as without limitation molten salt beds in one embodiment.

For electric power generation, the PCM Green Boiler is configured and functions to boil and superheat the boiler feed water (feedwater) for the Rankine power generation cycle to produce electric power “on demand” whenever the grid faces a deficit of electricity to meet current demand Thus, when the grid faces a power deficit, the Green Boiler can serve as a peaking power generation unit further replacing traditional smaller natural gas or diesel peak power generation units used during electric load swing periods of the power grid. In other words, the Green Boiler is activated when the power demand exceeds supply available from the base load units in the power grid. Thus, the traditional large “base load” polluting fossil-fueled power plant with fossil-fueled boiler is converted into an on-demand clean energy generator for a peak power generation role.

From a sociological standpoint, the reconfigured power plant will continue to employ its workers (after some retraining) and thus there will be little impact on the plant's host communities. However, the source of hydrocarbon air emissions is advantageously eliminated. In addition, for coal fired power plants, the residual flyash and bottom ash resulting from burning the coal in the boiler is eliminated as well. Since some coal-fired plants use wet sluicing as a method to handle the ash, the costs associated with waste water treatment and cleanup to remove suspended solids, “heavy metals,” or other constituent contained in the ash from such waste steams to meet regulatory discharge limits are mitigated.

In principle, the conversion of environmentally unclean boilers to the Green Boiler technology can be applied to any fossil plant in the world without exception. Thus, the decarbonization of the power generation economy can be carried out without delay and with maximum expediency. Scoping calculations show that the Green Boiler conversion is far and away the cheapest route to decarbonization of the existing fossil-burning plants in respect of capital cost. The operating cost likewise is lower than any other energy storage and delivery technology.

Replacing existing fossil coal-burning, oil-burning, or natural gas-burning boilers with a “Green Boiler” comprising an assembly of fluidly interconnected and heated phase change material (PCM) containment vessels, each of which in one embodiment stores thermal (heat) energy in molten salts, is one non-limiting aspect of the innovative green energy storage and power generation system disclosed herein.

The molten salt PCM containment vessels are each configured and operable to heat and melt the solid salt particles contained therein with electricity extracted from the power grid (or a co-located clean energy plant) via an array of heating elements embedded in the salt inventory or bed when the available power generation supplied to the grid exceeds demand Each PCM containment vessel comprises a tube bundle including a plurality of heat exchanger tubes fluidly isolated from the molten salt bed to convey and flow the boiler feedwater of the Rankine cycle through the vessel on the interior tube-side of the tubes. The shell-side of vessel (outside the tubes within each vessel) contains the molten salt which is in intimate and direct contact with the exterior of the tubes. During operation of the electric power grid to which the electric generator of the Green Boiler Rankine cycle is electrically connected, the Green Boiler uses the thermal energy stored in the molten salt to heat the boiler feedwater in a cascade of salt beds at successively higher melting points contained in the heat exchanger vessels to produce steam. The steam is flowed to and drives the steam turbine, which in turn rotates the electric generator mechanically coupled thereto in a known manner to generate electricity “on demand” during peak load demand periods of the grid.

In one embodiment, the molten salt PCM containment vessels of the Green Boiler system are elongated and may include, in fluid communication on the water side, an optional preheater which preheats the boiler feedwater (still in liquid phase), a boiler which heats and converts the water to wet (i.e. saturated) steam, and a superheater which dries the steam (i.e. removes moisture) to superheated conditions which is supplied to the steam turbine. The preheater may be omitted if the incoming boiler feedwater is sufficiently hot. A steam collection vessel may be included in some embodiments upstream of the steam turbine which receives and collects the superheated steam directly from the superheater vessel. All of the foregoing vessels are preferably heavily insulated for heat retention and may be collected housed within a common enclosure structure or housing. The vessels may be vertically oriented and elongated in one embodiment, and mounted on a reinforced concrete support pad on grade or elevated.

In the retrofit and replacement fossil-fueled boiler program, it bears noting the Green Boiler system is sized so that the enthalpy of the superheated steam is the design-basis steam of the fossil boiler it is replacing. Thus, the balance of the power plant equipment can be used without modification since there is no change in the thermal duty of the equipment.

For district heating applications, one or more heated PCM containment vessels of similar construction to those noted above uses the thermal energy stored in the molten salt bed to heat and produce hot water which may be pumped and distributed to the local town or city for heating buildings. The water is heated such as to about 200 degrees F. (Fahrenheit) and remains in a saturated but un-boiled state for heating purposes. Multiple heated molten salt containment vessels may be arranged and fluidly coupled together in a parallel flow arrangement to supply the total volume of hot water needed for district heating purposes. Advantageously, this provides a modular system in which additional PCM containment vessels may be added over time as the demand for district heating increases with population and infrastructure growth.

In one aspect, a thermal energy containment vessel comprises: an elongated body defining an internal cavity containing a bed of phase change material operable to store thermal energy; an array of heaters embedded in the phase change material, the heaters being configured for electrical coupling to an electric power source and operable to heat and melt the phase change material to a molten state; a tube bundle comprising a plurality of heat exchanger tubes embedded in the molten phase change material, the heat exchanger tubes configured to convey a working fluid through the heat exchanger tubes to absorb thermal energy from the molten phase change material. The phase change material may be salt and the working fluid may comprise water alone or a water mixture (e.g., water and glycol).

In another aspect, a thermal energy storage and power generation system comprises: a closed flow loop comprising in fluid communication a steam turbine, a steam condenser, a boiler assembly, and a pump operable to circulate boiler feedwater through the closed flow loop; an electric generator operably coupled to the steam turbine and an electric power grid; the boiler assembly comprising a thermal energy boiler vessel and a thermal energy superheater vessel fluidly coupled to the boiler vessel, each vessel comprising: an elongated tubular body defining an internal cavity containing a bed of molten phase change material operable to store thermal energy; an array of heaters embedded in the molten phase change material, the heaters electrically coupled to the electric power grid and being energized to heat the molten phase change material; a tube bundle comprising a plurality of heat exchanger tubes embedded in the molten phase change material, the heat exchanger tubes configured to convey the boiler feedwater through a tube-side of the heat exchanger tubes; wherein the thermal energy boiler vessel is configured to receive the feedwater in a liquid state which is heated by the molten phase change material therein to generate saturated steam, and the thermal energy superheater vessel is configured to receive the saturated steam which is heated by the molten phase change material therein to superheated conditions; and wherein the superheated steam flows through the steam turbine which rotates the generator and produces electricity. In some embodiment, the system further comprises a thermal energy preheater vessel fluidly coupled to the closed flow loop upstream of the boiler vessel. The preheater vessel may be configured similarly to and have the same features as boiler and superheater vessels. The phase change material may be salt, and a different type salt may be used in each vessel.

In another aspect, a method for heating a working fluid comprises: providing a thermal energy containment vessel comprising an internal cavity containing a bed of a phase change material in a solid state, and a tube bundle comprises a plurality of tubes embedded in the bed of the phase change material; energizing a plurality of heating elements embedded in the bed of the phase change material which heats and changes the phase change material from the solid state to a molten state; and flowing the working fluid at a first temperature through the molten phase change material which heats the working fluid to a higher second temperature. The phase change material may be salt and the working fluid may comprise water alone or a water mixture (e.g., water and glycol). In some embodiments, the water is in a liquid state entering the vessel and heated by the phase change material from a first temperature to a higher second temperature of the liquid state. In other embodiments, the water is in a liquid state entering the vessel and heated by the phase change material to convert the water to steam. In yet other embodiments, the water is saturated steam entering the vessel and heated by the phase change material to superheated steam.

### BRIEF DESCRIPTION OF THE DRAWINGS

The features of the exemplary embodiments of the present invention will be described with reference to the following drawings, where like elements are labeled similarly, and in which:

FIG. 1A is a schematic diagram of a conventional Rankine power generation cycle system using a polluting fossil-fueled boiler to produce steam;

FIG. 1B is a schematic diagram of a Rankine power generation cycle system according to the present disclosure including a non-polluting thermal energy storage Green Boiler according to the present disclosure to produce steam for the cycle;

FIG. 2 is a perspective view of the Green Boiler comprising a set of thermal energy storage vessels according to the present disclosure;

FIG. 3 is a partial perspective view of one of the upper portion of one of the thermal energy storage vessels of FIG. 2;

FIG. 4 is a partial perspective view of the lower portion thereof;

FIG. 5 is a partial perspective view similar to FIG. 3 but with the top closure lid of the vessel in cross section as well;

FIG. 6 is a top perspective view of the upper portion of the tube bundle of the vessel;

FIG. 7 is a top perspective view of the lower portion of the tube bundle;

FIG. 8 is a bottom perspective view of the upper portion of the tube bundle;

FIG. 9 is a bottom perspective view of the lower portion of the tube bundle;

FIG. 10 is a side view of the thermal energy storage vessel;

FIG. 11 is a top view thereof;

FIG. 12 is a bottom view thereof;

FIG. 13 is a vertical/longitudinal cross sectional view thereof taken from FIG. 10;

FIG. 14 is an enlarged view thereof taken from FIG. 13;

FIG. 15 is a transverse cross sectional view taken from FIG. 14;

FIG. 16 is a top perspective view of a first embodiment of a heat exchanger tube cartridge of the tube bundle configured for six pass tube-side flow of the working fluid through the vessel;

FIG. 17 is a bottom perspective view thereof;

FIG. 18 is a first side view thereof;

FIG. 19 is a second side view thereof;

FIG. 20 is a vertical/longitudinal cross sectional view thereof taken from FIG. 18;

FIG. 21 is a top view thereof;

FIG. 22 is bottom view thereof;

FIG. 23 is a top perspective view of a second embodiment of a heat exchanger tube cartridge of the tube bundle configured for three pass tube-side flow of the working fluid through the vessel;

FIG. 24 is a bottom perspective view thereof;

FIG. 25 is a first side view thereof;

FIG. 26 is a second side view thereof;

FIG. 27 is a perspective view thereof showing the tube-side working fluid flow path through the tube cartridge;

FIG. 28 is a vertical/longitudinal cross sectional view thereof;

FIG. 29 is a top view thereof;

FIG. 30 is bottom view thereof;

FIG. 31 is a top perspective view of a third embodiment of a heat exchanger tube cartridge of the tube bundle configured for single pass tube-side flow of the working fluid through the vessel;

FIG. 32 is a bottom perspective view thereof;

FIG. 33 is a first side view thereof;

FIG. 34 is a second side view thereof;

FIG. 35 is a vertical/longitudinal cross sectional view thereof;

FIG. 36 is a top view thereof; and

FIG. 37 is bottom view thereof;

All drawings are schematic and not necessarily to scale. Parts given a reference numerical designation in one figure may be considered to be the same parts where they appear in other figures without a numerical designation for brevity unless specifically labeled with a different part number and described herein. References herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

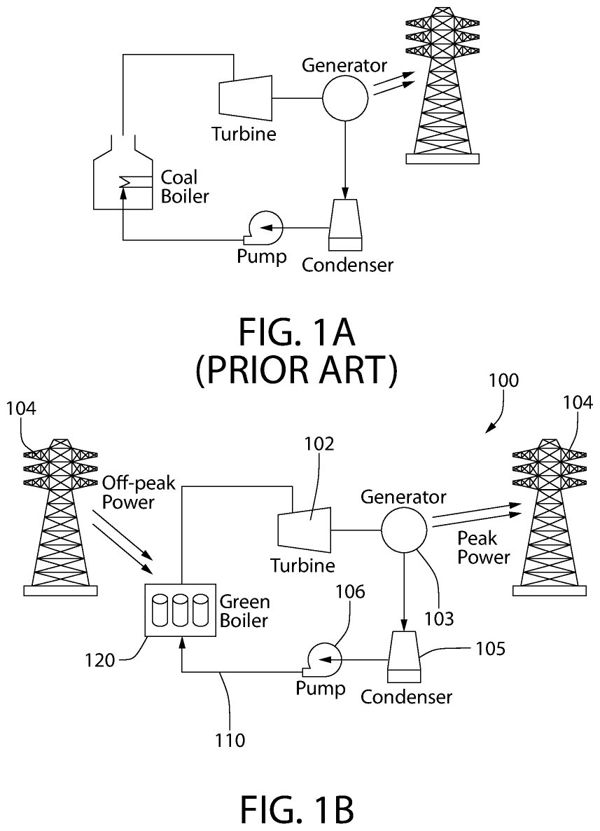

FIG. 1A shows a conventional power generation steam-to-electric Rankine power generation cycle with a large-scale fossil-fueled boiler to generate steam necessary for power production. The basic cycle equipment (excluding auxiliary systems) includes the fossil fuel fired boiler (e.g., coal, oil, or natural gas), steam turbine-generator set, steam condenser which condenses steam exhausted from the steam turbine back into a liquid state, and boiler feedwater pump which takes such from the condenser circulates the boiler feedwater (heat exchange working fluid) through a closed flow loop formed by piping which fluidly couples the components together as shown. The electric generator is mechanically coupled to steam turbine and electrically coupled to the power grid (represented by the power line transmission tower shown). Steam produced by the boiler rotates the turbine shaft via the rows of turbine blades, which in turn rotates the rotor of the generator within the stator (magnets) to convert mechanical energy into electric energy in a known manner. The Rankine cycle power generator system and its operation for generating electric power is well known to those skilled in the art without further elaboration necessary.

The fossil-fueled boilers (steam generators) in Rankine systems which convert the boiler feedwater in a liquid state to steam are traditionally used for base electric load operation to satisfy the base load demand of the power grid since such boilers and associated auxiliary equipment cannot be quickly started for on-demand power generation. In fact, the entire startup process for fossil-fueled base load plants takes many hours to bring all equipment up to full pressure and temperature operating conditions to reach full load.

FIG. 1B depicts a clean energy “green” Rankine power generation cycle system including a steam generator comprising the non-polluting “Green Boiler” technology according to the present disclosure. The Green Boiler replaces the fossil-fueled steam boiler of FIG. 1A with thermal energy containment vessels which are configured as both a containment for the phase change material (PCM) and a heat exchanger, as further described herein. In one embodiment, the PCM is molten salt.

The present thermal energy storage and power generation system 100 may be configured and used as a “peaking” power generation system to generate and supply power to the power grid during peak load demand periods. Conversely, electric energy extracted from the power grid during “off-peak” load demand periods when there is a surplus of energy in the grid is used to “charge” the molten salt beds of the Green Boiler as previously described herein.

The green thermal energy storage and power generation system 100 shown in FIG. 1B may include without limitation steam turbine 102, electric generator 103 mechanically coupled thereto and operably connect to the electric power grid 104, steam condenser 105, boiler feedwater pump 106, and a molten salt laden thermal energy storage boiler 120. The feedwater pump circulates the boiler feedwater through close flow loop 110 formed by piping which fluidly couples the water bearing components of the Rankine cycle together as shown. With exception of the present green boiler assembly, the remaining components of the clean energy Rankine cycle operate in the same foregoing and known manner as a traditional Rankine cycle to produce electricity.

For the on-demand electric power generation application used in the foregoing Rankine cycle, thermal energy storage boiler 120 may be an assembly comprising a plurality of fluidly coupled and interconnected thermal energy containment vessels 121. The vessels may include in order of the working fluid flow an optional thermal energy preheater vessel 121A, a thermal energy boiler vessel 121B, and a thermal energy superheater vessel 121C. The vessels are piped in series flow arrangement as shown (see directional working fluid flow arrows). The working fluid in the illustrated embodiment comprises water, which may be boiler feedwater in the Rankine cycle of FIG. 1B In some embodiments if the incoming feedwater from the condenser is sufficiently hot enough, the preheater vessel may be omitted. If used, the preheater vessel receives the feedwater in a “cool” liquid state at a first temperature and heats the feedwater to a higher second temperature still in a liquid state. The heated feedwater flows to the boiler vessel where it is further heated and changes phase from a liquid state to saturated steam which flows to the superheater vessel. The superheater vessel heats the saturated steam to superheated conditions. The superheated steam flows in closed flow loop 110 to and drives the steam turbine 102 (FIG. 1B) which rotates the generator shaft or rotor to generate electricity which is fed back into the electric power grid.

Since the preheater, boiler, and superheater vessels 121A, 121B, and 121C receive the working fluid (e.g., water in liquid state or steam) at different temperatures and must heat the fluid to different temperatures and conditions, the PCM (phase change material) used in each vessel may be different in at least one characteristic, including for example without limitation melting temperature and/or type of PCM. The PCM may be a salt with suitable properties for the heat duty required.

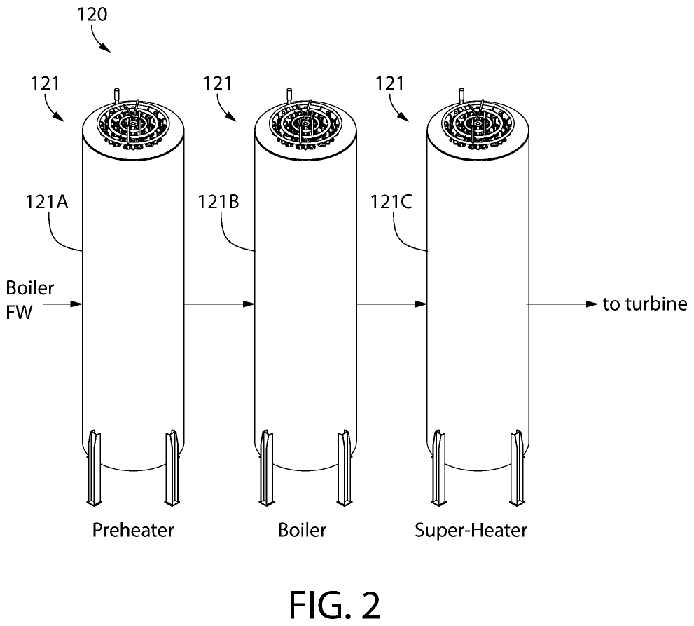

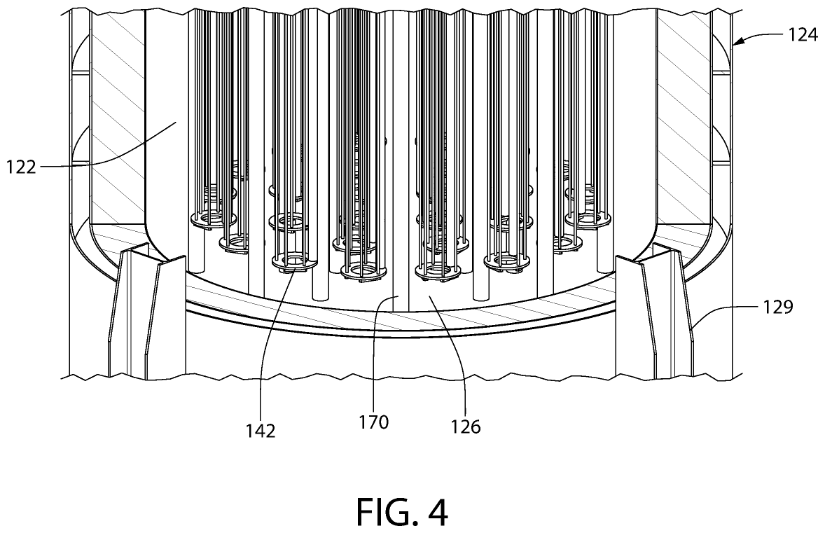

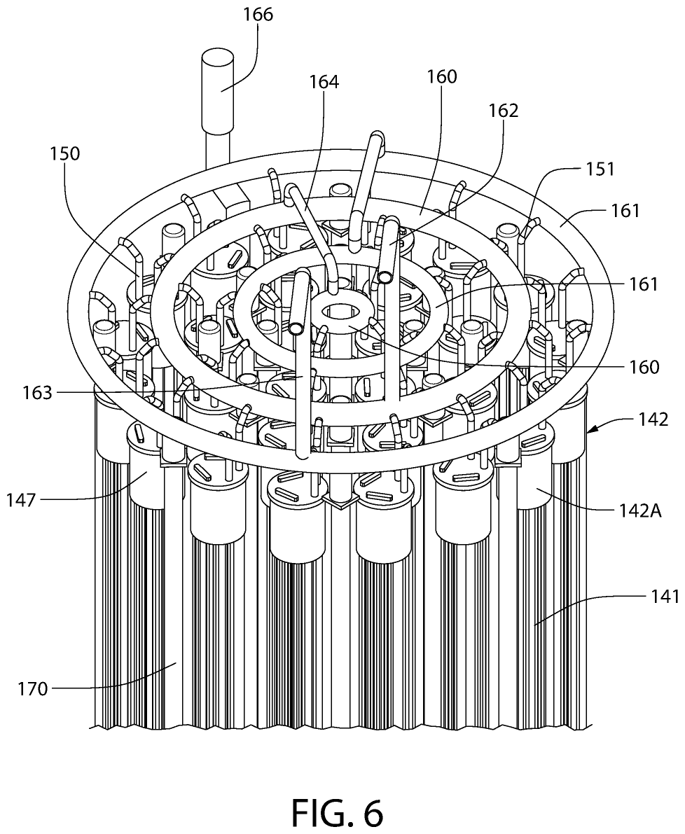

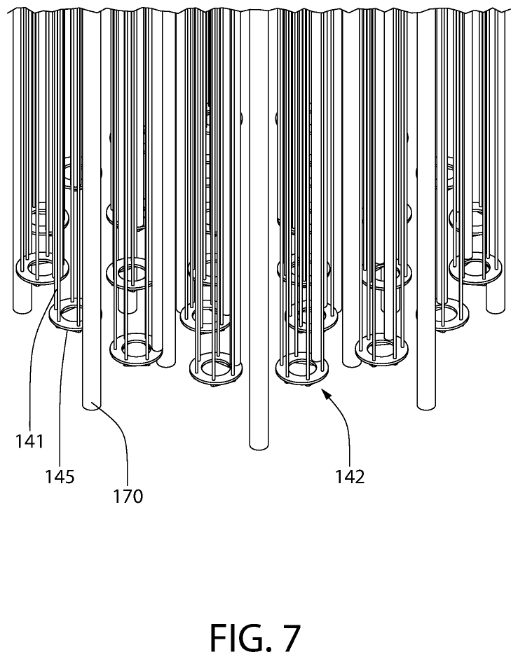

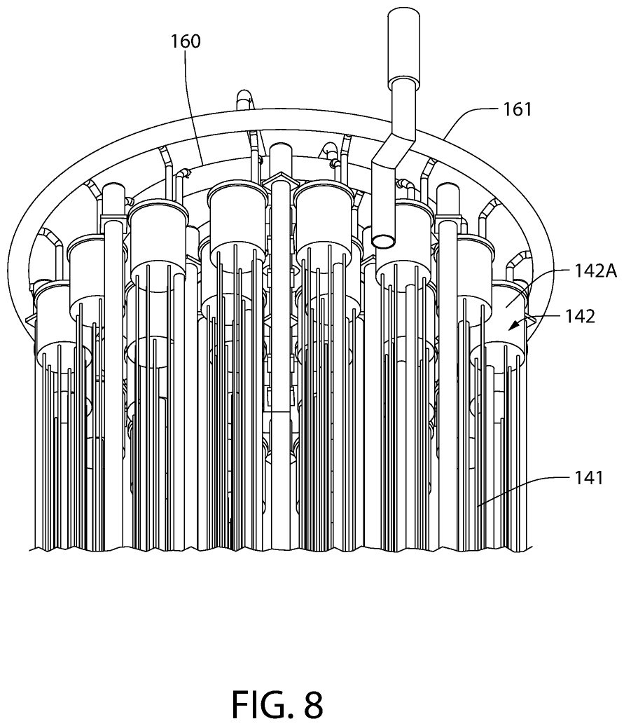

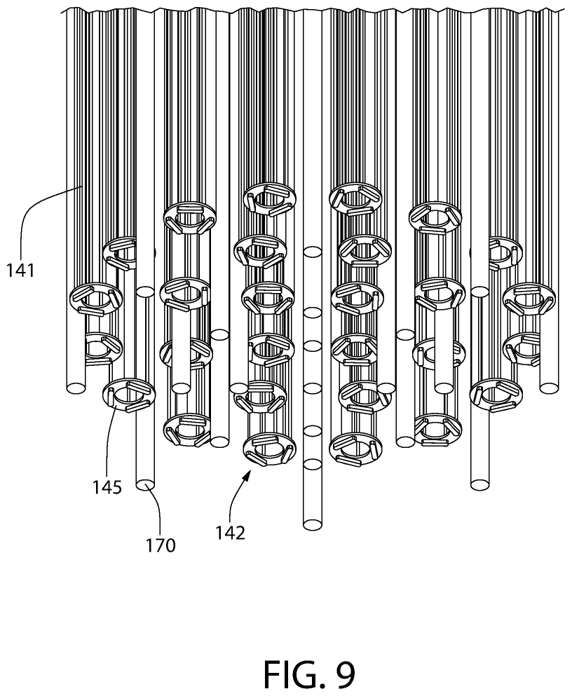

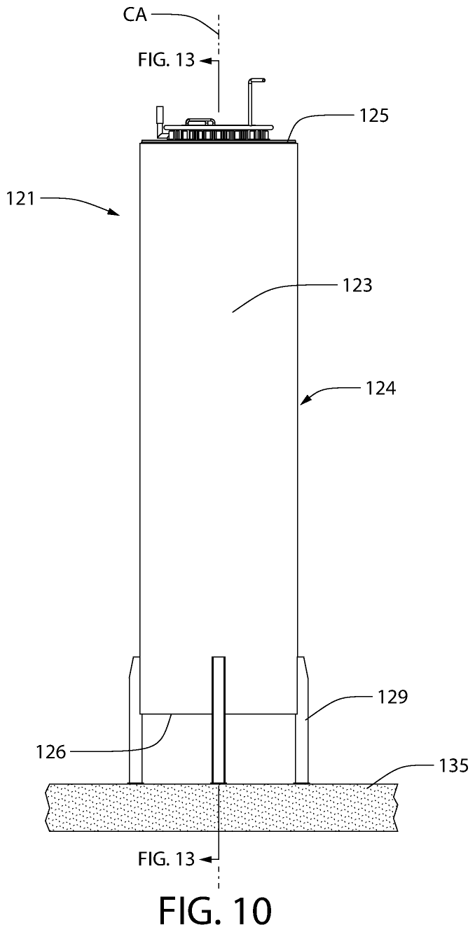

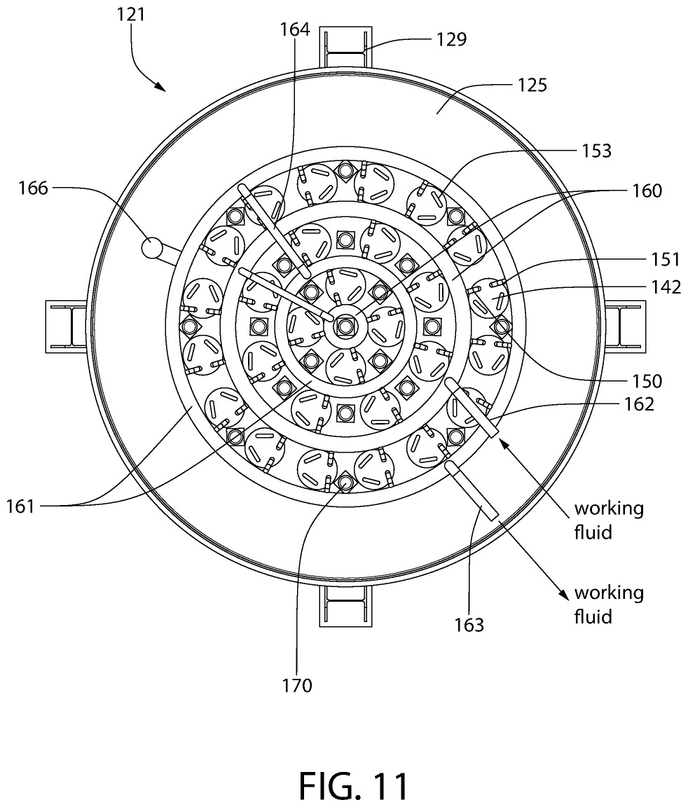

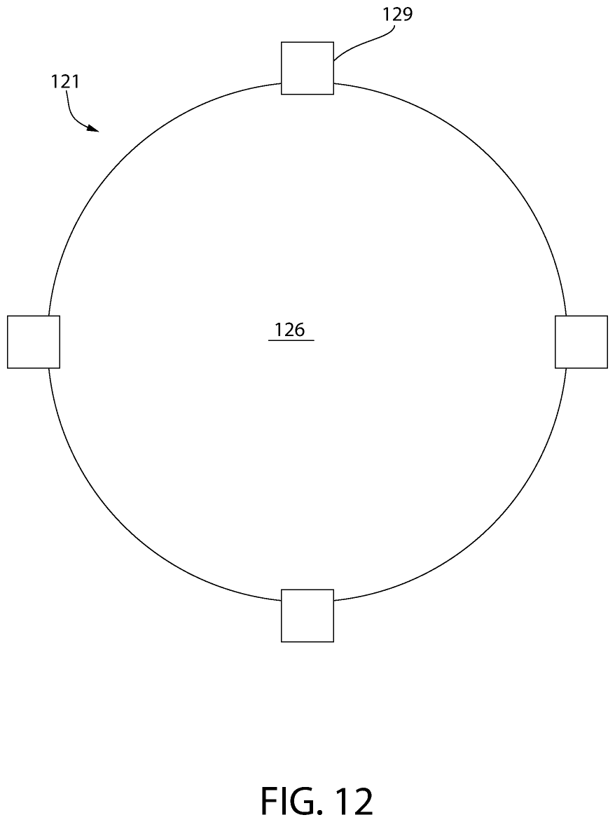

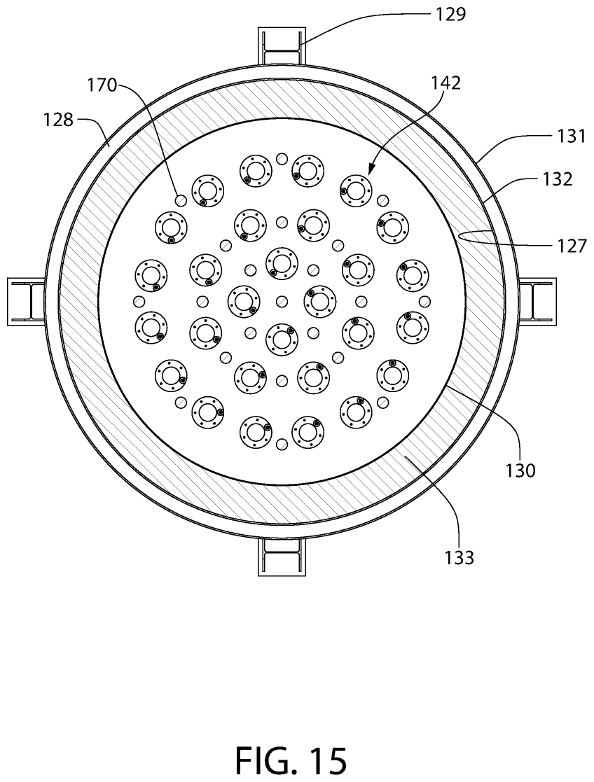

Referring initially to FIGS. 2-15 as applicable, each vessel may have similar construction generally comprising a vertically oriented and elongated body 123 defining a vertical centerline axis CA passing through the geometric center of the vessel. The vessel bodies each include a vertical internal cavity 122 extending for substantially the entire height the vessel (which excludes the thickness of the top and bottom closure structures of the vessel). The cavities each contain a bed B of molten salt which is contained in a captive state within the vessel such that the molten salt does not flow into or out of containment vessels 121 during operation of the boiler. Only the working fluid such as boiler feedwater FW flows through the vessels in a cascading serial manner, as further described herein.

The thermal energy containment vessel bodies 123 may be cylindrical in shape in one embodiment as defined by a cylindrical vertical sidewall 124 which defines the internal cavity 122 of the vessel. Each vessel includes a top closure lid 125 coupled to the top end of sidewall 124 and defines a top of the vessel, and a bottom closure plate 126 is coupled to the bottom end of the sidewall and defines a bottom of the vessel. The lid 125 and bottom closure plate 126 are sealed to ends of the sidewall and enclose the cavity 122 in a fluid tight manner to serve as a containment for the molten salt bed without leakage. In one embodiment, the lid 125 and bottom closure plate 126 may be sealed welded to each end of the cylindrical vessel sidewall 124. In another embodiment, the lid 125 may be detachably coupled to the top end of the vessel body 123 (e.g., sidewall 124) via a plurality of threaded fasteners such as bolts. Other detachable fastening methods may be used.

The thermal energy containment vessels 121 may be supported by and mounted on a reinforced concrete pad 135 in a vertical orientation as shown. In one embodiment, each vessel may comprise a plurality of structural legs 129 which elevated the bottom of the vessels above the concrete pad. The legs may be welded to the lower portion vessel bodies 123 and secured to the concrete pad via a plurality of anchor bolts (not shown) or any other suitable method for stability particularly during a seismic event.

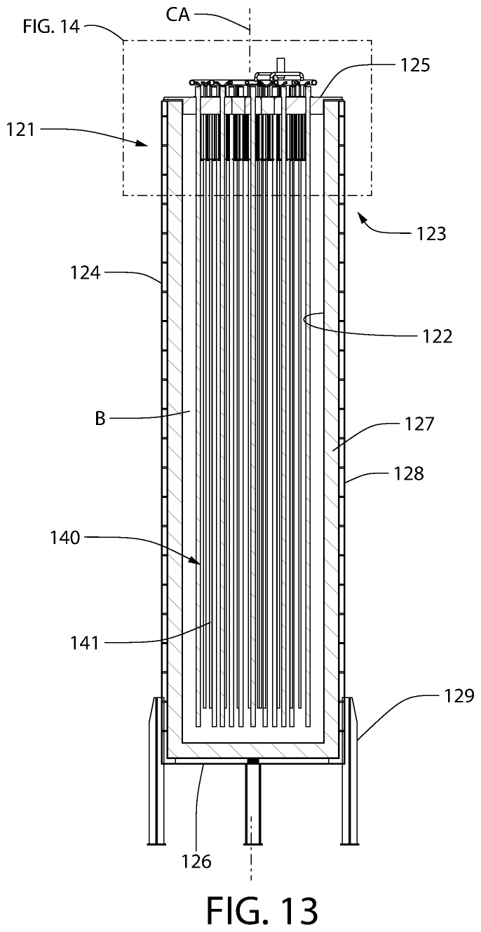

The cylindrical sidewall 124 of the vessel body 123 may have a composite construction comprising an innermost shell 130, outermost shell 131, and an intermediate shell 132 disposed proximate to but spaced radially apart from the outermost shell (see, e.g., FIGS. 13-15). Accordingly, intermediate shell 132 is closer to the outermost shell than innermost shell. Each shell 130-132 has a hollow tubular cylinder shape.

The bodies 123 of the thermal energy containment vessels 121 including the shells 130-132, top closure lid 125, and bottom closure plate 126 may be formed of a suitable metal such as steel including preferably stainless steel in one embodiment. These parts of the vessel body may be welded together to form a welded assemblage with possible exception of the top closure lid 125 which may be detachably coupled to the sidewall 124 in some embodiments.

In one embodiment, a vacuum annulus 128 may be provided and formed between the outermost and intermediate shells 131, 132. The vacuum annulus is evacuated and sealed to sub-atmospheric (i.e. negative) pressures or a vacuum V which serves to thermally insulate the thermal energy containment vessels 121 internally within the sidewall structure. In one embodiment, vacuum annulus may be evacuated to about 0.5 Torr. A plurality of vertically spaced apart annular shell support ribs 134 may be mounted between outermost and intermediate shells 131, 132 to prevent collapse of the vacuum annulus 128 when exposed to the vacuum inside. The ribs 134 are formed of a metallic material (e.g., steel or preferably stainless steel) and welded to shells 131 and 132. Ribs 134 may be insulated in some embodiments to reduce conductive heat transfer out of the vessel cavity 122 to the outermost shell 131.

In one embodiment, the opposing surfaces of the outermost and intermediate shells 131, 132 which may be formed of stainless steel that face inwards towards the vacuum annulus 128 are highly polished to form reflective surfaces for reflecting heat back inwards and increase the insulating value of the vacuum annulus.

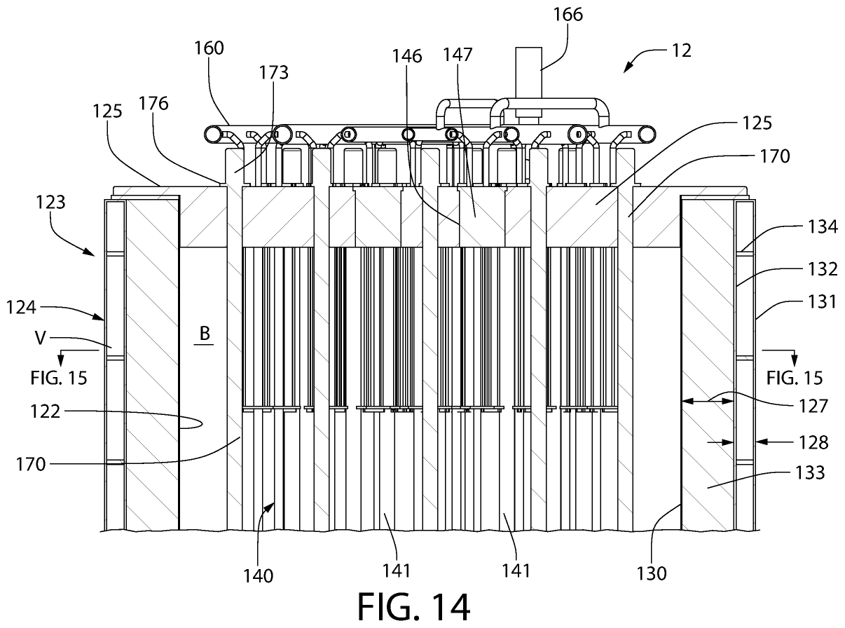

To further thermally insulate the thermal energy containment vessels 121, an insulation annulus 127 may be formed between the innermost and intermediate shells 130, 132 as shown. Insulation annulus 127 may have a greater radial width than the vacuum annulus 128 and contains a suitable thermal insulation material 133. It bears noting that each of the insulation and vacuum annuluses 127, 128 extend for at least the entire height of the vessel cavity 122 which contains the molten salt bed B, and in some embodiments for the entire height of the sidewall 124 (see, e.g., FIGS. 13 and 14).

The thermal energy containment vessels 121 each further comprise a tube bundle 140 including a plurality of heat exchanger tubes 141 embedded in but fluidly isolated from the molten salt bed B. The working fluid such as water (including boiler feedwater of the Rankine cycle in FIG. 1B) or another type flows through the inside (interior tube-side) of the tubes through the each vessel. The shell-side of vessel (outside the tubes) contains the molten salt which is in intimate and direct conformal contact with the exterior of the tubes for heat transfer. Heat exchanger tubes may extend for greater than 90 percent of an entire height of the cavity 122 of the vessel to maximize the heat transfer surface area of the tube bundle.

In one embodiment, heat exchanger tubes 141 of the tube bundle 140 may be segregated, arranged, and clustered in a plurality of individual tube cartridges 142 each removably insertable into the vessel 121 through a corresponding complementary configured cartridge opening 146 formed the top closure lid 125 of the vessel. The cartridges 142 advantageously are replaceable without removing the top closure lid 125 to access the internal cavity of the vessel 121, which makes tube replacement more expedient and reduces replacement costs. The tubes in each cartridge may be arranged and configured for single pass or multiple passes of the working fluid vertically through the molten salt bed B in the vessel cavity 122 to absorb heat therefrom for heating the working fluid.

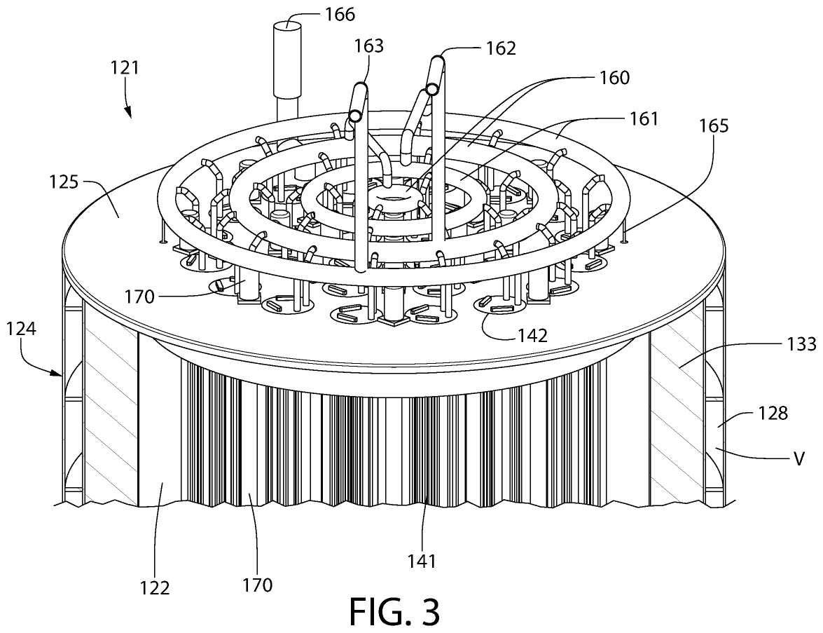

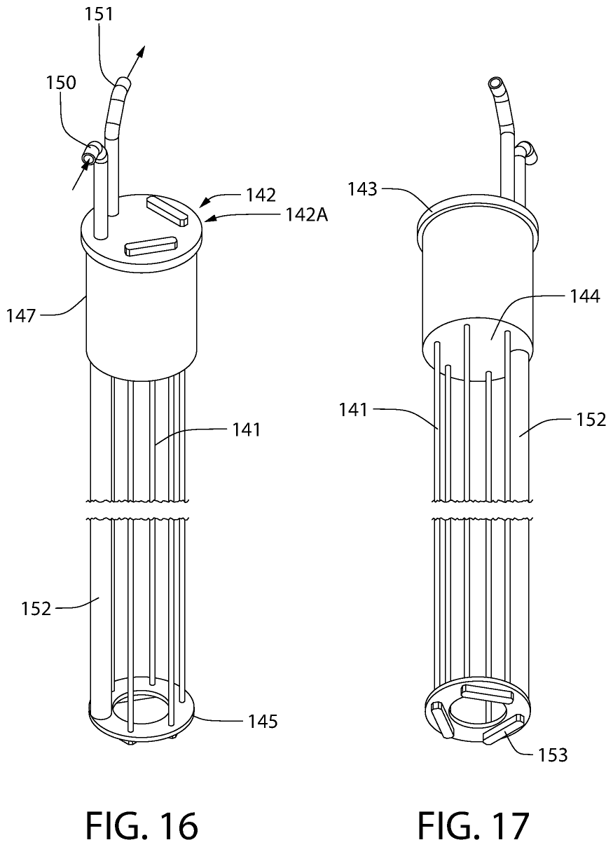

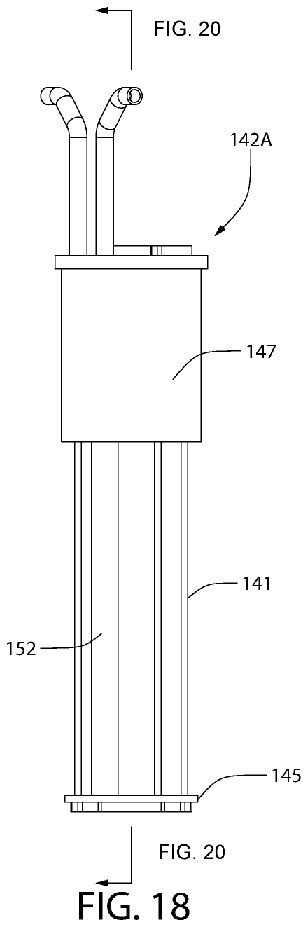

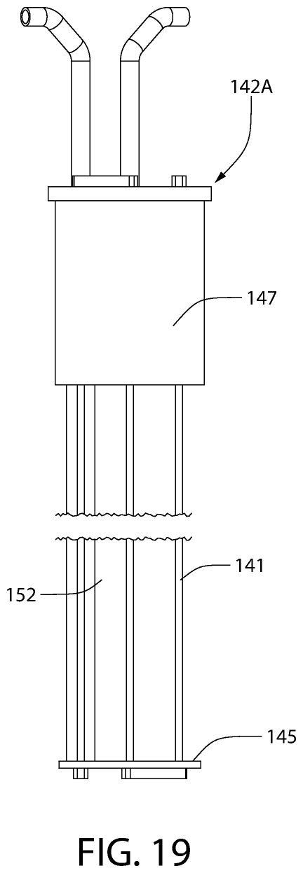

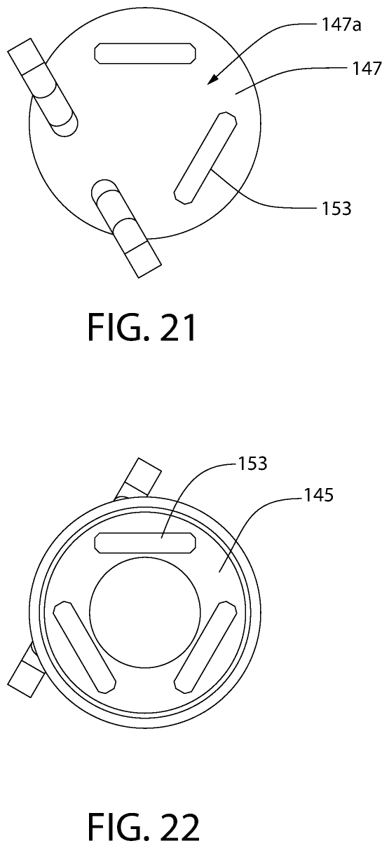

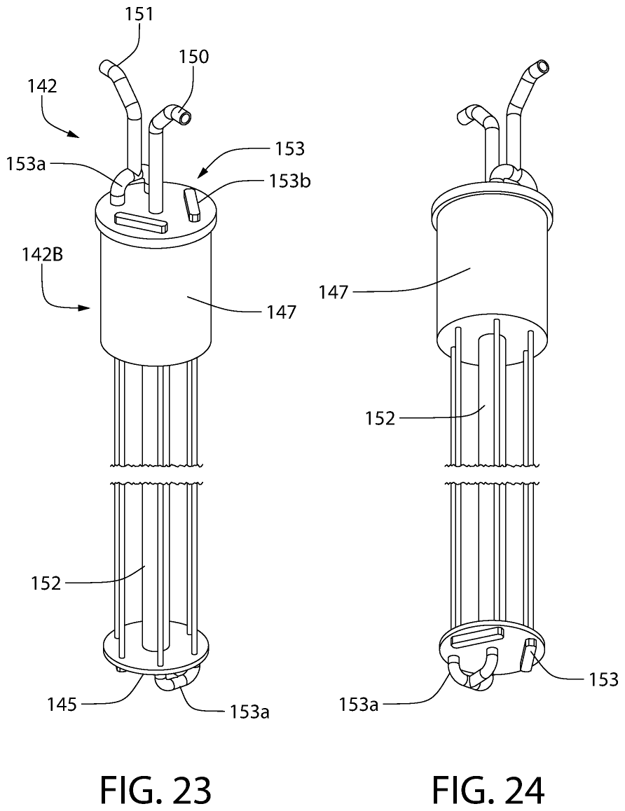

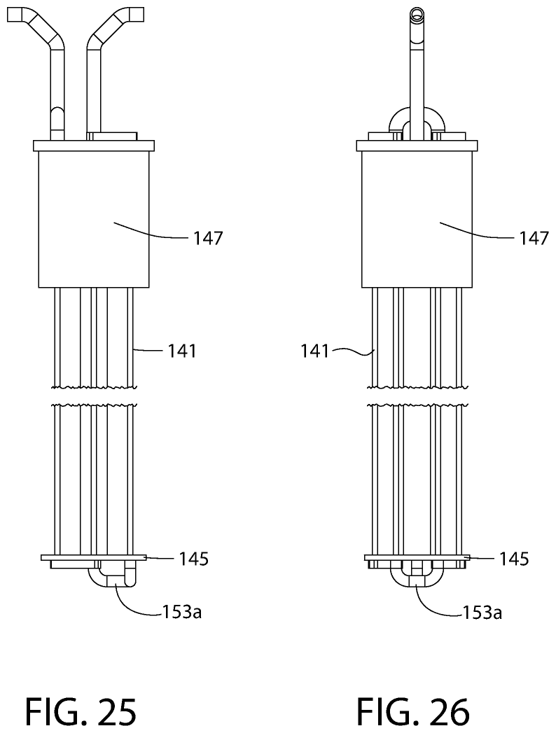

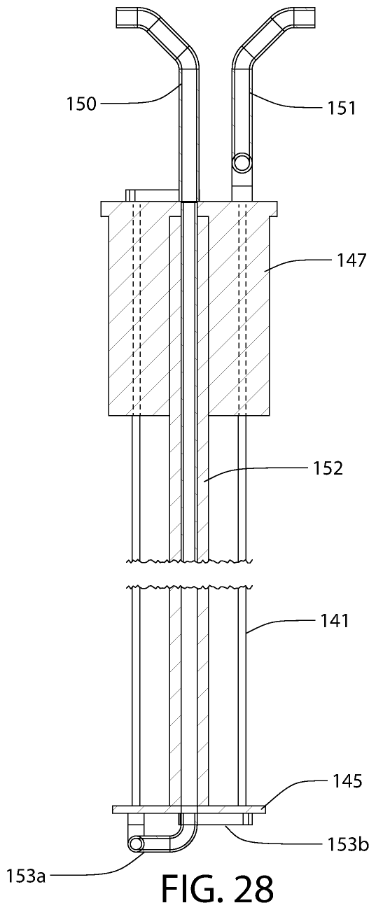

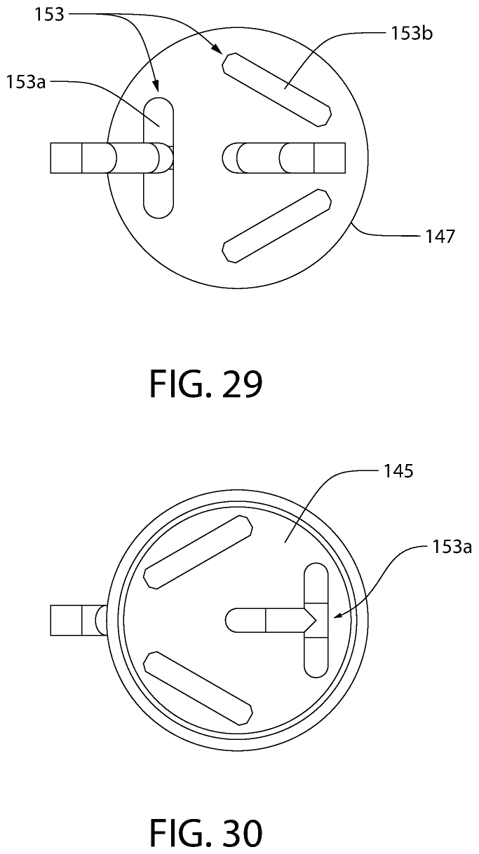

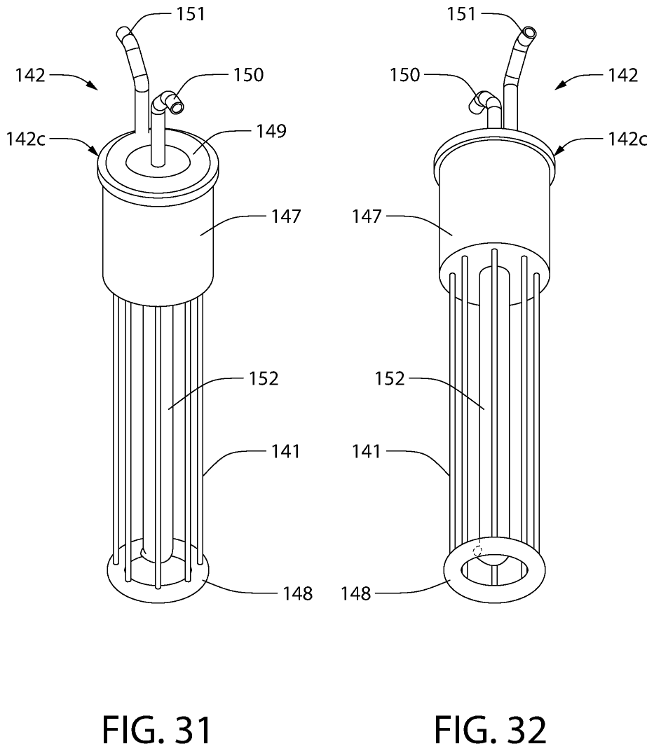

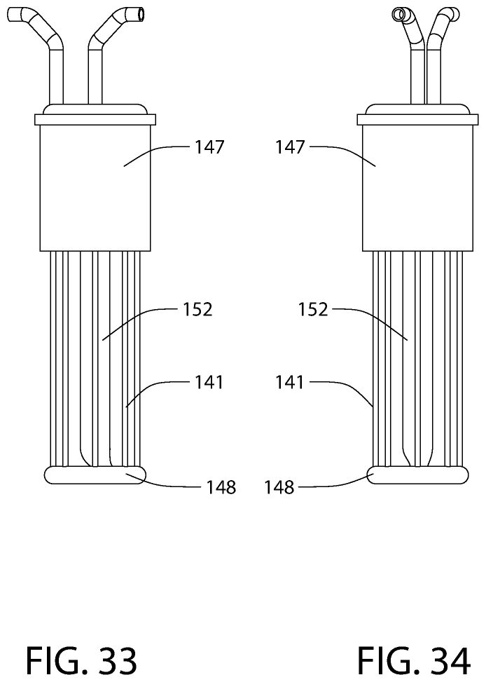

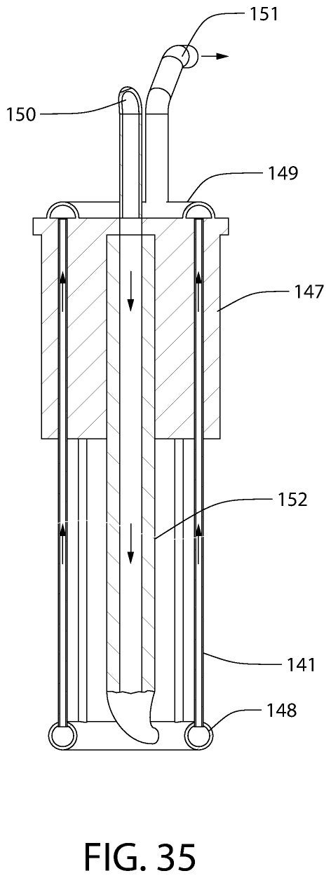

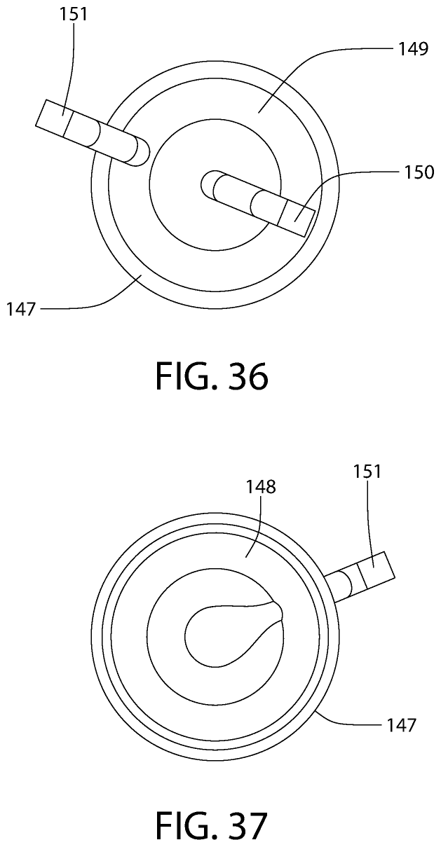

FIGS. 16-22 depict a first embodiment of a tube cartridge 142 comprising a 6-pass tube cartridge 142A for discussion, which is variously depicted in an installed state in a thermal energy storage vessel 121 in FIGS. 3-15 where shown. As some additional examples, FIGS. 23-30 depicts a 3-pass tube cartridge 142B. FIGS. 31-37 depict a single pass tube cartridge 142C. Any number of tube passes suitable for the intended application to sufficiently heat the working fluid such as water or another heated with the PCM-bearing thermal energy containment vessel 121 to the desired temperature may be used. Regardless of the number of passes, each tube cartridge 142 shares similar features which will now be described in further detail with respect to the 6-pass tube cartridge 142A.

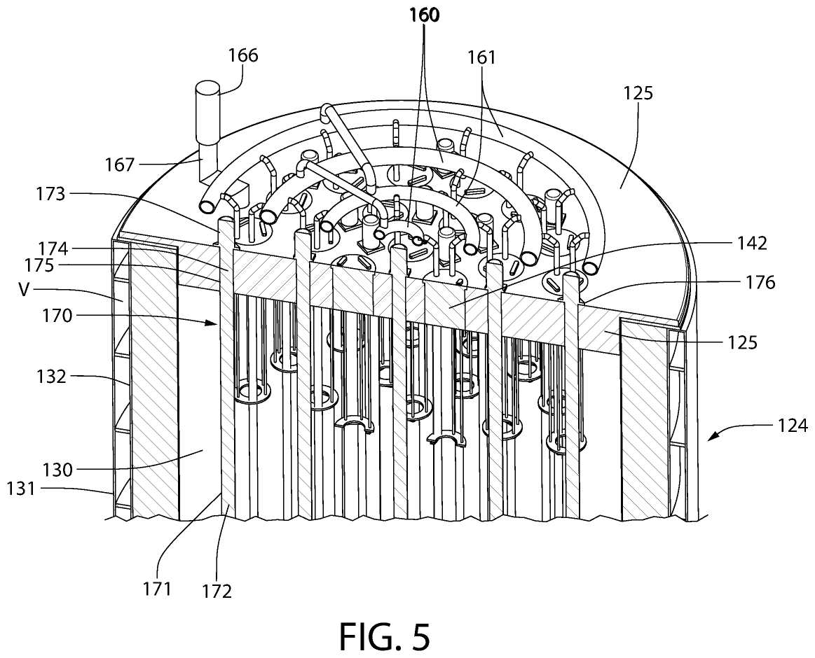

Referring generally to FIGS. 3-22 as applicable, each tube cartridge 142 (e.g., 142A, 142B, 142C) comprises a metallic cylindrical head 147 of solid structure in one embodiment including an upper surface 147a and opposing bottom surface 147b. Head 147 has a thickness substantially coextensive with the thickness of the vessel top closure lid 125 (see, e.g., FIGS. 5 and 14). Head 147 is insertable into a respective circular cartridge opening 146 of top closure lid 125 and coupled to the lid 125 in a fixed and fluid-tight sealed manner such as via seal welding so that the PCM when molten or associated vapor cannot escape to ambient atmosphere via the tube cartridge to lid interface. Each tube cartridge 142 may be fully supported by the vessel lid 125 in a suspended and vertically cantilevered manner as shown such that no portion of the tube cartridge 142 or it heat exchanger tubes 141 are supported by any portion of the vessel below the lid. Tube cartridges 142 are vertically oriented and elongated in structure as shown.

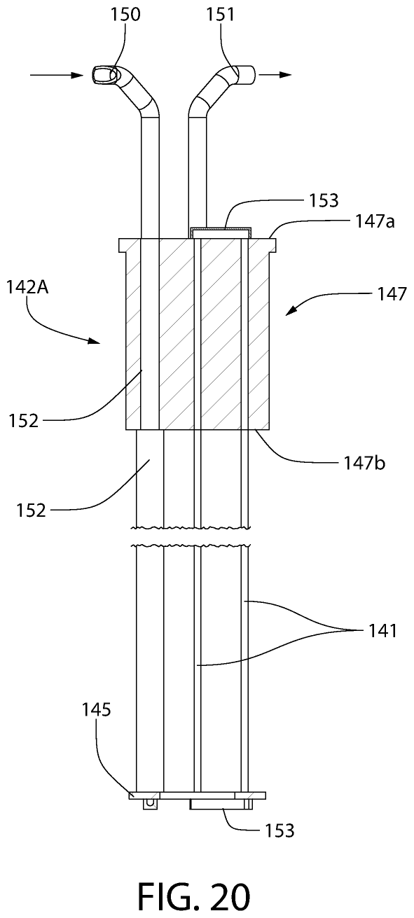

The heat exchanger tubes 141 extend vertically from the tube cartridge head 147 in parallel to each other to a metallic lower tube support plate 145. Plate 145 may have any suitable shape, such as an annular flat ring as shown. The top ends of the tubes rigidly mounted and coupled to the tube cartridge head 147 and extend completely therethrough as best shown in FIG. 20. The bottom ends of the tubes 141 extend completely through and are rigidly coupled to the lower tube support plate 145. The tubes may be sealed welded to the cartridge head 147 and lower tube support plate 145. It bears noting that the lower tube support plate 145 is not fixedly attached to the body of the vessel 121 so as to be slideably removable from the vessel cavity 122 with the tube cartridge 142.

Each tube cartridge 142 further comprises a cartridge fluid inlet 150 for introducing the working fluid such as water (e.g., boiler feedwater or other) or steam in some uses, and a cartridge fluid outlet 151 for discharging the water or steam after it has been heated. The inlet and outlet may be formed by sections of pipe of any suitable configuration, which may have a larger diameter than the diameter of the heat exchanger tubes 141. The inlet and outlet are rigidly mounted and coupled to the tube cartridge head 147 for support. The inlet 150 is fluidly coupled to a downcomer pipe 152 which vertically extends completely through the head 147 and is coupled to the lower tube support plate 145 (see, e.g., FIG. 20). The downcomer may be coupled and sealed welded to the top surface of lower tube support plate in some embodiments. A flow hole (not visible) in the tube support plate 145 directly beneath and within the downcomer pipe 152 allows the inlet water flow stream to pass through and below the plate for redirection to another heat exchanger upflow tube 141.

Continuing general reference is made to the 6-pass tube cartridge 142A shown generally in FIGS. 3-15 in an installed state as applicable, and specifically in isolation in FIGS. 16-22. The 6-pass tube cartridge 142A comprises heat exchanger tubes 141 configured so that the water makes multiple passes (e.g., six) through the bed of molten PCM (phase change material) as the water (or steam in some cases) becomes successively heated to higher and higher temperatures by absorbing heat from the PCM bed. Accordingly, some of the heat exchanger tubes 141 of each tube cartridge for any multi-pass tube cartridge are upflow tubes and some may be downflow tubes. The upflow tubes of each tube cartridge may be fluidly coupled to a corresponding downflow tube member by a cross-flow conduit 153, and vice-versa for creating the multi-pass tube flow arrangement. A plurality of cross-flow conduits 153 are sealably attached (e.g., welded) to the top surface of tube cartridge head 147 and cross-flow conduits 153 are sealably attached to the lower tube support plate 145. The cross-flow conduits reverse the flow of water/steam 180 degrees either up or down in the tube cartridge 142.

It bears noting that the cross-flow conduits 153 may be configured for fluid coupling to a single heat exchanger tube 141, or multiple tubes depending on the flow design path in the tube cartridge 142. Accordingly, the cross-flow conduit may split and distribute the flow stream from a heat exchanger tube 141 or fluid inlet 150 to multiple tubes (see, e.g., tee-shaped inlet cross-flow conduit 153a in FIG. 24 or 30), or combine flow from multiple heat exchanger tubes into a single flow stream (see, e.g., tee-shaped outlet cross-flow conduit 153a in FIG. 23, 27, or 29).

Any suitable configuration of cross-flow conduits 153 may be used so long a leak-proof fluid coupling is made between the upflow and downflow tubes, including for example without limitation box-shaped conduits (153b), circular pipe section conduits (153a), or others. It bears noting that the cross-flow conduits 153 may also be used to fluidly couple the fluid inlet 150 and outlet 151 to the upflow a corresponding upflow tube.

FIGS. 23-30 depicts a 3-pass tube cartridge 142B which is similar to the 6-pass tube cartridge 142A described above in construction. Similar features are labelled similarly and are already described above. Some differences in configuration/construction are that the lower tube support plate 145 has a solid circular shape and the downcomer 152 is centrally located as opposed to being radially offset as in the 6-pass tube cartridge 142A (see, e.g., FIG. 16).

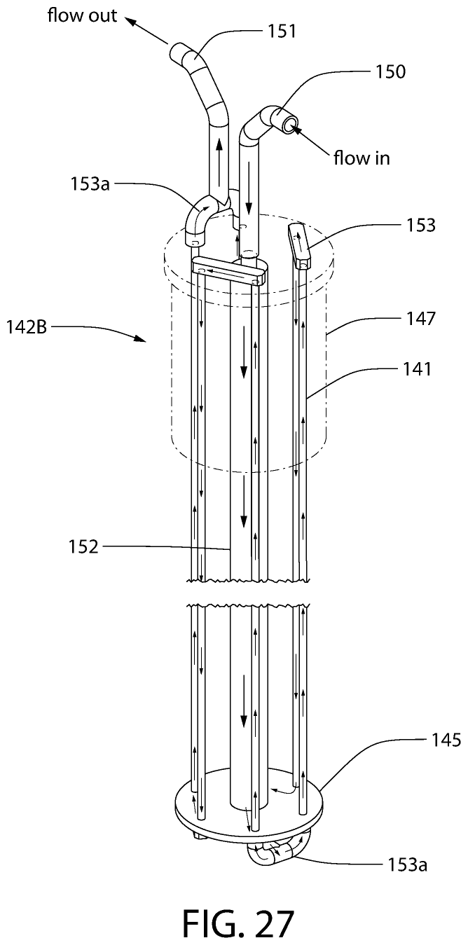

FIG. 27 showing the 3-pass tube cartridge 142B includes tube-side fluid flow arrows showing the path that the working fluid such as water (in liquid or steam state) travels through the tube cartridge 142B in vertically passing through the PCM bed B inside the thermal energy containment vessels 121. The heat exchanger tubes 141 which function as either upflow or downflow tubes is evident. The same methodology is applicable to the 6-pass tube cartridge 142A or any multiple pass tube cartridge having other numbers of passes through the PCM.

FIGS. 31-37 depict a single pass tube cartridge 142C which again is generally similar to the 3-pass and 6-pass tube cartridge 142A described above in construction. Similar features are labelled similarly and are already described above. One difference is that the lower tube support plate of the multi-pass tube cartridges is replaced with a lower annular header 148 formed by a circular section of piping. The centrally located downcomer 152 is fluidly coupled to the annular header. The bottom ends of the heat exchanger tubes 141 in turn are fluidly coupled directly to the annular header 148 as shown. In operation, the working fluid (e.g., water or other) flows vertically downwards through the downcomer pipe 152 and enters the annular header 148 from which the flow is equally distributed to the heat exchanger tubes. The flow then travels upwards through the tubes making a single pass inside the tubes through the PCM bed B for absorbing heat therefrom. In one embodiment, the single pass tube cartridge may include an upper annular header 149 formed by a circular section of piping which receives the upward flowing working fluid from the tubes to which the top ends of the tubes are fluidly coupled. Annular header 149 is mounted to the top surface of the upper head 147 of the tube cartridge as shown.

The tube cartridges 142 regardless of numbers of passes have a fully metallic construction. including head 147 and lower tube support plate 145. The fluid inlet 150, fluid outlet 151, cross-flow conduits 153, and lower annular header 148 of the single pass tube cartridge 142C are preferably formed of a suitable metallic material, such as steel or stainless steel. Stainless steel is generally preferred and used where possible due to its corrosion resistance. The heat exchanger tubes 141 may be made of any suitable material including stainless steel when possible. The type of tube material can be selected for compatibility and use with the particular type of PCM material used so as to not be corrosively affected by the chemistry of the PCM material. Other metallic materials may be used for any of the foregoing components.

To distribute the inflowing cool working fluid (e.g., water or steam in one embodiment) to the tube cartridges 142, or collect the outflowing heated working fluid from the tube cartridges, each thermal energy containment vessels 121 comprises a plurality of inlet and outlet headers. In one embodiment, metallic annular or circular ring headers may be provided including inlet ring headers 160 and outlet ring headers 161 best shown in FIGS. 3, 5, 6, 8, and 11. The illustrated embodiment includes a pair of inlet ring headers 160 and pair of outlet ring headers 161. The inlet and outlet ring headers are concentrically arranged and aligned with respect to each other. Accordingly, the ring headers may have different diameters to form the nested arrangement shown. Further, the inlet and outlet ring headers may be alternated such that the inlet and outlet ring headers are not adjacent to each other, but interspersed. One inlet ring header 160 includes a header inlet pipe 162 which receives the cool working fluid for distribution, and one outlet ring header 161 includes a header outlet pipe 163 which discharges the heated working fluid collected from the tube cartridges 142. Jumper pipes 164 may be used to fluidly couple the two inlet ring headers 160 together so that the incoming working fluid is transferred from one ring header to the other. The same arrangement and jumper pipes 164 may be used for fluidly coupling the two outlet ring headers 161 together as shown. The number of inlet and outlet ring headers depends on how many tube cartridges 142 are provided and their arrangement. The fluid inlets 150 from each tube cartridge 142 are fluidly coupled to one of the inlet ring headers 160. The fluid outlets from each tube cartridge are fluidly coupled to one of the outlet ring headers 161.

In one embodiment, the vessel inlet and outlet ring headers 160, 161 may be positioned above and supported by top closure lid 125 of the thermal energy containment vessel 121. In one embodiment, structural standoff members 165 may be used to elevate each of the ring headers above and support them from the top surface of the lid (shown schematically in FIG. 3). Any type of structural member (rods, angles, etc.) may be used. The ring headers 160, 161 are formed of s suitable metal, such as steel or preferably stainless steel.

In operation, the incoming cool working fluid flow such as water (liquid or steam form) enters the first inlet ring header 160 from the header inlet pipe 162. A portion of the flow is transferred to the second inlet ring header 160 via the one or more jumper pipe(s) 164. In other embodiments, the incoming working fluid may be bifurcated and evenly split to both inlet ring headers simultaneously in lieu of series flow. The same applies to arrangement and flow scheme of the outgoing flow and outlet ring headers 161 in reverse.

In either case, the incoming flow is distributed from each inlet ring header 160 to the tube cartridges 142 where the fluid makes a single or multiple passes through the PCM bed of the vessel 121 and becomes heated. The heated working fluid (in liquid or steam form) is collected from the tube cartridges by the pair of outlet ring header 161 and discharged via the fluid outlet 181 of the vessel 121. In one embodiment, the vessel fluid outlet 181 may be fluidly coupled and connected to one of the outlet ring headers 161. The header inlet pipe 162 similarly may be fluidly coupled and connected to one of the inlet ring headers 160. The inlet and outlet pipes 162 163 may be formed of suitable metallic piping having a suitable configuration.

The heat exchanger tubes 141 may develop cracks and leak over time as the granular PCM undergoes cyclical phase changes between a liquid/molten state to an at least partially solid state each time the PCM's stored heat (thermal energy) is transferred to and absorbed by the water flowing through the PCM bed B inside the heat exchanger tubes 141. The caustic nature of some PCMs such as certain molten salts also have a corrosive effect on the tube materials which may cause cracking and leaks over time. Either of these situations require tube replacement and downtime of the affected thermal energy containment vessels 121.

Advantageously, the tube cartridges 142 disclosed herein allow individual cartridges and their associated tubes (some of which may be leaking) to be rapidly swapped out and replaced with an identical new fully preassembled tube cartridge without removing closure lid 125 of the thermal energy storage vessel 121. This eliminates the need to replace or plug individual leaking heat exchanger tubes on a piece-meal basis which is a time consuming process. The damaged and leaking tube(s) of the old tube cartridge may be replaced/repaired after the thermal energy containment vessel 121 is returned to service. This dramatically simplifies the maintenance and repair of the vessel and cuts downtime, thereby allowing the vessel to return to active service faster to minimize loss in revenue.

Each thermal energy containment vessel 121 provided includes an array of heaters embedded in the molten phase change material (PCM) and operable to heat the PCM. The heaters are configured for electrical coupling to an available source of electricity such as via any suitable commercially-available electric contacts or connectors necessary for the intended application. The electric power source may be the commercial regional electric power grid controlled by public utilities, or a local power source such as electric power generation at an industrial plant in some case. The heaters convert electric power received from the electric power source to thermal energy which is used to heat the PCM.

FIGS. 3-14 variously show the PCM heaters. In one embodiment, the heaters 170 comprise a plurality of vertically elongated bayonet heating elements 170 comprising an inner ceramic core 172 and an outer metallic sheath 171 in direct contact with the PCM inside the internal cavity 122 of the thermal energy containment vessel 121. The heating elements are vertically elongated/oriented and may have a cylindrical configuration. Heating elements 170 are interspersed in a radial array between the vertical tube cartridges 142 and their associated heat exchanger tubes 141 as shown. Any suitable number of heating elements may be provided to sufficiently heat and melt the PCM as required.

The upper end portion 174 of the heating elements 170 are each disposed in and pass through complementary configured opening 175 in top closure lid 125 of thermal energy containment vessel 121 (see, e.g., FIGS. 5 and 14). Upper portion 174 defines a radially protruding annular mounting flange 176 which is seated on the exposed top surface of the top closure lid 125 of the vessel. The top cylindrical electrical coupling boss 173 of each element 170 protrudes upwards from the lid and contains the electrical contacts/terminals for making the electric connection to the electric power supply or source for the vessel 121.

The heating elements 170 are detachably mounted to the top closure lid 125 of the thermal energy containment vessel 121 in a suspended and vertically cantilevered manner similarly to the individual heat exchanger tube cartridges 142 previously described herein. Accordingly, there is no support for the heating elements within the internal cavity 122 of the vessel below and other than the top lid. The heating elements 170 advantageously are replaceable without removing the top closure lid 125 to access the internal cavity of the vessel 121, which makes heating element replacement more expedient and reduces replacement costs.

In some embodiments, the heating elements 170 have vertical length or height which extends for a majority of, and substantially the entire height of the internal cavity 122 of vessel 121 which contains the PCM (see, e.g., FIG. 13). In some embodiments, the heating elements 170 have a longer vertical height or length than the heat exchanger tube cartridges 142. This ensures that the entire captive bed of granular PCM (when in the solid state/form) in the vessel cavity 122 is exposed to heat from the heating elements and melted when the heating elements are energized.

When the tube cartridges 142 and heating elements 170 are installed in the thermal energy containment vessel 121, the granular PCM fills the interstitial spaced between the tubes 141, downcomer pipes 152, and heating elements before the elements are energized. When the heating elements are energized, the granular PCM particles are converted to a liquid or molten state occupying the same internal space within cavity 122 of the vessel and in direct conformal contact with the components for maximum heat transfer to the working fluid inside the tubes.

To initially fill the thermal energy containment vessel 121 with the PCM, a combination fill and pressure relief device 166 is provided which is configured to penetrate the top closure lid 125 of the vessel (see, e.g., FIG. 5). Device 166 is fluidly coupled to the internal vessel cavity 122 via PCM transfer piping 167 of suitable configuration. The device is openable to fill the PCM and closeable after the PCM fill is complete. In the event the pressure inside the thermal energy containment vessels 121 exceed a preselected maximum setpoint pressure of the device, the device will open to relieve the excess pressure to atmosphere. Any suitable commercially available device or a custom device may be used to provide the required functionality.

According to another aspect of the invention, the thermal energy storage system advantageously is modular in nature. In other words, multiple thermal energy containment vessels 121 may be provided for any given installation to meet the design and operational requirements of the facility utilizing them to heat a working fluid via the thermal energy stored in the PCM (phase change material) bed inside each vessel. Potential applications for the system include the production of hot water (or water mixtures such as glycol and water) for district heating, industrial processes, or other heated liquid uses, and the generation of steam for steam heating, industrial processes, electric power generation, or other uses. The number of thermal energy containment vessels 121 deployed is selected to produce a working fluid be it in liquid or gaseous (e.g., steam) state of sufficient volume/amount and temperature to meet the intended application needs. In addition, extra working fluid heating capacity may be added over time with the present modular system as demand grows such as for example without limitation increases in population and infrastructure (e.g., housing, etc.) in a district heating or other application.

To meet the capacity and temperature requirements for the heated working fluid, individual thermal energy containment vessels 121 may be fluidly coupled in serial flow arrangement (see, e.g., FIG. 2), or in parallel flow arrangement. Accordingly, any suitable flow scheme may be used. It is well within the ambit of those skilled in the art to select the number, thermal service duty, and fluidic arrangement of thermal energy containment vessels 121 as needed.

Any suitable PCM (phase change material) may be used which is customized and selected for the required thermal duty and operating parameters (i.e. heat the working fluid which may be water/water mixtures from an inlet temperature entering the thermal energy storage vessel 121 to desired outlet temperature). In preferred but non-limiting embodiments, the PCM is salt which may be converted from a granular solid state to a molten state when heated by heating elements 170 when energized by electric power extracted from an available power source such as the electric power grid or another source. Any suitable salt may be used which is selected for the required thermal duty.

Some examples of salts which may be used to form the PCM bed B in each thermal energy storage vessel 121 are shown in the following table:

| Tₘₑₗₜ | | Latent Heat |
|---|---|---|
| (° C.) | Material | (kJ/kg) |
| 94 | 60 wt % AlCl₃ + 14% KCl + 26% NaCl | 213 |
| 150 | 66 wt % AlCl₃ + 34% NaCl | 201 |
| 202 | 7.5 wt % NaCl + 23.9% KCl + 68.6% ZnCl₂ | 200 |
| 258 | 59 wt % NaOH + 41% NaNO₃ | 292 |
| 307 | NaNO₃ | 177 |
| 318 | 77.2 mol % NaOH − 16.2% NaCl − 6.6% Na₂CO₃ | 290 |
| 320 | 54.2 mol % LiCl − 6.4% BaCl₂ − 39.4% KCl | 170 |
| 335 | KNO₃ | 88 |
| 340 | 52 wt % Zn − 48% Mg | 180 |
| 348 | 58 mol % LiCl − 42% KCl | 170 |
| 370 | 26.8% NaCl − 73.2% NaOH | 320 |
| 380 | KOH | 149.7 |
| 380 | 45.4 mol % MgCl₂ − 21.6% KCl − 33% NaCl | 284 |
| 381 | 96 wt % Zn − 4% Al | 138 |
| 397 | 37 wt % Na₂CO₃ − 35% K₂CO₃ − 31% Li₂CO₃ | 275 |
| 430 | 56 wt % NaCl − 44% MgCl₂ | 168 |
| 443 | 59 wt % Al − 35% Mg − 6% Zn | 310 |
| 450 | 48 wt % NaCl − 52% MgCl₂ | 430 |
| 470 | 36 wt % KCl − 64% MgCl₂ | 388 |
| 487 | 56 wt % Na₂CO₃ − 44% Li₂CO₃ | 368 |
| 500 | 33 wt % NaCl − 67% CaCl₂ | 281 |
| 550 | LiBr | 203 |
| 632 | 46 wt % LiF − 44% NaF₂ − 10% MgF₂ | 858 |
| 658 | 44.5 wt % NaCl − 55.5% KCl | 388 |
| 714 | MgCl₂ | 452 |
| 801 | NaCl | 510 |

The melt temperatures and latent heat properties of the salt are properties and factors which direct the selection of the type salt for the required thermal duty and temperature increase of the working fluid. It bears noting that the type of salt used in each thermal energy storage vessel 121 for the Green Boiler 120 in the green thermal energy storage and power generation system 100 application shown in FIG. 1B (i.e. preheater, boiler, and superheater) may therefore be customized and different. Regardless of the application including simply heating water for district heating or other applications, it is apparent to those skilled in the art that thermal duty and performance of the thermal energy storage vessel 121 is highly customizable to meet the required temperature increase objectives of the thermal energy system.

Although the thermal energy containment vessels 121 disclosed herein are described without limitation for heating water (e.g., boiler feedwater, water mixtures such as water and glycol, or ordinary water) for various purposes and applications via the thermal energy absorbing PCM bed, the invention is not limited in this regard. Accordingly, the thermal energy containment vessels 121 may be used to heat any and other type of fluid which are flowable through the heat exchanger tubes of the vessel. Accordingly, enumerable applications of the green thermal energy storage system 100 are possible and within the scope of the present disclosure.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A thermal energy containment vessel comprising:
an elongated body defining an internal cavity containing a bed of phase change material operable to store thermal energy;
a plurality of heaters embedded in the phase change material, the heaters being configured for electrical coupling to an electric power source and operable to heat and melt the phase change material to a molten state;
a tube bundle comprising a plurality of heat exchanger tubes embedded in the molten phase change material, the heat exchanger tubes configured to convey a working fluid through the heat exchanger tubes to absorb thermal energy from the molten phase change material.

2. The vessel according to claim 1, wherein the working fluid comprises water.

3. The vessel according to claim 2, wherein the vessel is configured to convert the water from a liquid state entering the vessel to steam exiting the vessel.

4. The vessel according to claim 2, wherein the vessel is configured to receive the water in a liquid state at a first temperature and discharge the water in a liquid state at a second temperature higher than the first temperature.

5. The vessel according to claim 2, wherein the vessel is configured to receive saturated steam at first steam temperature and discharge the steam in a superheated state at a second temp higher than the first steam temperature.

6. The vessel according to claim 1, wherein the body of the vessel is vertically elongated and cylindrical in shape, and the heat exchanger tubes are vertically elongated and parallel to each other such that the water flows vertically through the bed of molten phase change material inside the heat exchanger tubes.

7. The vessel according to claim 6, wherein the heaters comprise a plurality of vertically elongated bayonet heating elements comprising an inner ceramic core and an outer metallic sheath in direct contact with the molten phase change material, the heating elements being interspersed between the heat exchanger tubes.

8. The vessel according to claim 7, wherein the heating elements are supported from a top closure lid of the vessel in a vertically cantilevered manner.

9. The vessel according to claim 8, wherein the heat exchanger tubes of the tube bundle are arranged in a plurality of individual tube cartridges each removably insertable into the vessel through a respective opening in the top closure lid.

10. The vessel according to claim 9, wherein the tube cartridges each comprise an upper head coupled to a top closure lid of the vessel, a top end of the heat exchanger tubes in each cartridge extending through and coupled to the head.

11. The vessel according to claim 10, wherein the tube cartridges are supported from the top closure lid in a vertically cantilevered manner.

12. The vessel according to claim 9, wherein the heat exchanger tubes of each tube cartridge are configured so that the water makes multiple passes through the bed of molten phase change material so that the working fluid becomes successively heated to higher and higher temperatures with each pass.

13. The vessel according to claim 12, wherein some of the heat exchanger tubes of each tube cartridge are upflow tubes and some of the heat exchanger tubes are downflow tubes.

14. The vessel according to claim 13, wherein some of the upflow tubes of each tube cartridge are fluidly coupled to a corresponding downflow tube member by a cross-flow conduit attached to the upper tube support plate.

15. The vessel according to claim 14, wherein the tube cartridge further comprises a lower tube support plate coupled to a bottom end of the heat exchanger tubes, and the lower tube support plate is not fixedly attached to the body of the vessel so as to be slideably removable from the cavity with the tube cartridge.

16. The vessel according to claim 15, wherein the upflow tube members of each tube cartridge are fluidly coupled to a corresponding downflow tube member by a cross-flow conduit attached to the lower tube support plate.

17. The vessel according to claim 15 or 16, wherein each tube cartridge comprises a fluid inlet for introducing the working fluid into the tubes of the tube cartridge, and a fluid outlet for discharging the working fluid from the tube cartridge.

18. The vessel according to claim 8, wherein each tube cartridge comprises a downcomer pipe having a diameter larger than a diameter of each of the heat exchanger tubes in the tube cartridge.

19. The vessel according to claim 18, wherein the downcomer pipe is vertically oriented and fluidly coupled to a bottom end of at least one heat exchanger tube.

20. The vessel according to claim 19, wherein the downcomer pipe is supported by the upper head of the tube cartridge at top and a lower tube support plate at bottom.

21. The vessel according to claim 18, wherein a bottom end of the downcomer pipe is supported by and fluidly coupled to a lower annular header, and a top end of the downcomer pipe is supported by and fluidly coupled to an upper annular header mounted to the upper head of the tube cartridge, the heat exchanger tubes being fluidly coupled to the lower and upper annular headers.

22-54. (canceled)
